(19) United States
(12) Patent Application Publication
(10) Pub. No.: US 2010/0303550 A1
(43) Pub. Date: Dec. 2, 2010

(54) METHOD OF DRAINING LEACHATE FROM AN EXISTING LANDFILL

(75) Inventors: Phillip D. McKALIPS, Crozel, VA (US); Gerald L. Kirkpatrick, Downingtown, PA (US)

Correspondence Address: BUCHANAN, INGERSOLL & ROONEY PC, POST OFFICE BOX 1404, ALEXANDRIA, VA, 22313-1404, US

(73) Assignee: ENVIRONMENTAL STANDARDS, INC., Charlottesville, VA (US)

(21) Appl. No.: 12/471,606

(22) Filed: May 26, 2009

(51) Int. Cl. B09C 1/02

(52) U.S. Cl. 405/129.7; 405/129.85

(57) ABSTRACT

An existing landfill cell is retrofit with a lateral drainage pipe for draining leachate therefrom. The method involves installing an entry tube through a top surface of the landfill's cap, and sealing the entry tube with respect to surrounding material of the cap. Then, a drill string is introduced through the entry tube, and a drill bit on the drill string drills a hole through the solid waste along a path situated above the base of the landfill in an upwardly inclined direction from the entry opening. The leachate and drilling fluid are allowed to gravitate outwardly through the entry tube during the drilling operation. After installing a perforated drain pipe in the hole, a nozzle is passed through the drain pipe for emitting a high-pressure liquid jet generally radially outwardly through the drain pipe and into the surrounding solid waste to form a drainage layer of waste material around the drain pipe, allowing leachate to enter the drain pipe and gravitate from the landfill cell.

### BACKGROUND

A landfill cell is typically constructed by forming a liquid-impermeable liner over the soil surface (e.g., a layer of compacted clay located beneath a plastic membrane), followed by a layer of granular material, to form a base of the cell. Layers of solid waste materials, separated by layers of soil, are deposited upon the base, and eventually a cap is formed over the waste material to complete the cell. The cap may comprise layers of clay, plastic membrane, soil, geosynthetic material and vegetative cover. The cap has an exposed convexly shaped top surface, i.e., the surface has portions thereof situated at different respective elevations. Vertical vent wells are placed in the cell to vent methane gases that are then dealt with in a controlled way.

It is known that leachate from the solid waste can accumulate at the base of the cell and pose a health risk if it enters the ground water beneath the cell. An excessive build-up of leachate can also create hazardous conditions. For example, the leachate can block the gas inlet portions of the methane vent wells, resulting in the formation of a large volume of methane gas which migrates out of the cell in an uncontrolled way, creating odor problems and a potential explosion risk. Moreover, the leachate can undermine the stability of the cell itself, resulting in a landslide of landfill material to expose toxic substances to the environment, among other problems.

More modern landfill cells are typically constructed to include a leachate collection system having lateral (non vertical) drain pipes positioned within the granular material of the landfill base in order to drain leachate to collection zones for proper handling.

However, older completed landfill cells may not possess such collection systems, or existing systems may have failed to operate correctly. A common way of withdrawing excess leachate to acceptable levels in such cases involves drilling vertical wells downwardly into the cell and pumping-out the leachate upwardly through the wells. However, such a practice can be uneconomical and technically challenging, because numerous wells are required, and each well requires considerable vertical lift of liquid in the form of active pumping. Moreover, the wells must be installed through the landfill cap which, if engineered properly, is a low-permeability surface designed to resist penetration to a degree required of a vertical leachate-removal well.

In the case of a still-operating (non-closed) landfill, if it is discovered that the leachate collection system beneath the liner is non-functional, e.g., due to physical collapse, the materials overlying the collection system must be exhumed, and the collection system rebuilt, which may be a costly undertaking, depending on the degree of completion of the landfill cell.

It would, therefore, be desirable to provide a way of withdrawing built-up leachate from an existing (i.e., closed or operating) landfill cell in a relatively economical and technically simplified manner, especially by retrofitting the cell with one or more lateral leachate-removal wells.

### SUMMARY

There is disclosed herein a method of draining leachate from an existing landfill cell by retrofitting the landfill cell with a lateral drainage pipe. The landfill cell is of the type which includes a base, solid waste disposed above the base, and a cap overlying the solid waste. The base includes a liner and the cap includes a top surface having portions thereof situated at different respective elevations. The leachate is emitted from the solid waste and accumulates above the base. The method comprises the steps of:

A. installing an entry tube through the top surface of the cap, and sealing the entry tube with respect to surrounding material of the cap; then

B. introducing a drill string through the entry tube and causing a drill bit to drill a hole through the solid waste along a path situated above the base in an upwardly inclined direction from the entry opening;

C. allowing leachate and drilling fluid from the drill bit to gravitate outwardly through the entry tube during step B; then

D. installing a perforated drain pipe in the hole; then

E. passing a nozzle through the drain pipe for emitting a high-pressure liquid jet generally radially outwardly through the drain pipe and into the surrounding solid waste to form a drainage layer of waste material around the drain pipe, and

F. forming a seal between the drain pipe and the entry tube subsequent to step D; and

G. allowing leachate to enter the perforated drain pipe and drain from the landfill cell by gravity.

Another aspect of the disclosure involves creating a seal around the entry tube where the entry tube intersects the cap, by embedding the entry tube in a layer of clay-like material, such as bentonite, and surrounding the entry tube with a piece of plastic material, such as HDPE.

### BRIEF DESCRIPTION OF THE DRAWINGS

The following is a detailed description of the method in connection with the appended drawings in which like numerals designate like elements.

FIG. 1 is a schematic representation of a conventional landfill cell in which leachate has collected.

FIG. 2 is an enlarged fragmentary view of the cell of FIG. 1 after an entry tube has been installed through the cap of the cell.

FIG. 3 is a view similar to FIG. 2 showing a drill bit drilling a hole through the cell.

FIG. 4 is a view similar to FIG. 1 showing the hole passing completely through the cell.

FIG. 5 is an enlarged fragmentary view of an exit end of the hole after an exit tube has been installed therein.

FIG. 6 is a view similar to FIG. 5 showing a drain pipe about to be attached to a drill string disposed in the hole, in preparation for pulling the drain pipe through the hole.

FIG. 7 is a view similar to FIG. 4 showing the drain pipe extending through the entry tube, and a liquid jet nozzle being passed through the drain pipe.

FIG. 8 is a view similar to FIG. 5 showing the exit end of the drain pipe mounted in the exit tube.

FIG. 9 is an enlarged fragmentary view of the drain pipe within the landfill cell at the end of the method.

### DETAILED DESCRIPTION OF A PREFERRED EMBODIMENT

Disclosed hereafter is a method of retroactively installing a leachate collection system in an existing (i.e., a closed or still-operating) landfill cell. In particular, and as explained in detail hereafter, at least one but preferably a plurality of lateral (non-vertical) drainage wells is installed above the cell base by drilling at least one lateral hole through the cell's top surface and through the waste material in an upwardly inclined direction. After installing a drain pipe within the hole, a nozzle is passed through the drain pipe which emits a high-pressure liquid jet generally radially outwardly through the drain pipe and into the surrounding waste material to form a drainage layer of waste material around the drain pipe. The drill string extends through an entry tube positioned through the cap, during the drilling operation.

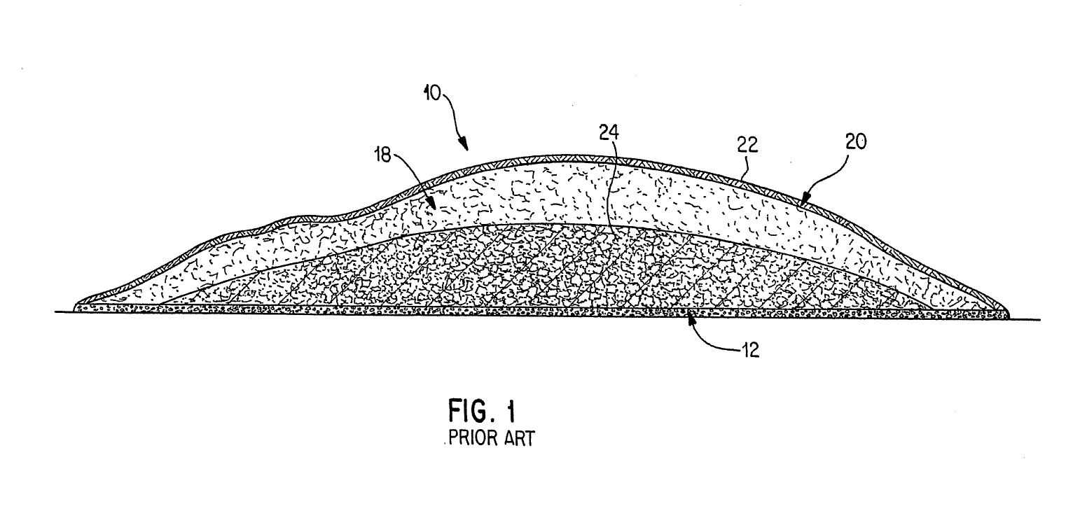

Depicted in FIG. 1 is a closed landfill cell 10 which includes a base 12 comprised of at least a liner and a layer of granular material laid over the liner. The liner can comprise a layer of compacted clay or a plastic liquid-impermeable membrane disposed over the compacted clay layer. A mass of solid waste 18 is disposed upon the granular material in the form of alternating layers of waste and soil. Finally, the waste material is overlaid with a cap 20 usually comprised of layers of clay, plastic membrane, soil, geosynthetic material and vegetative cover. The top surface 22 of the cap is generally convex and includes portions thereof located at different respective elevations.

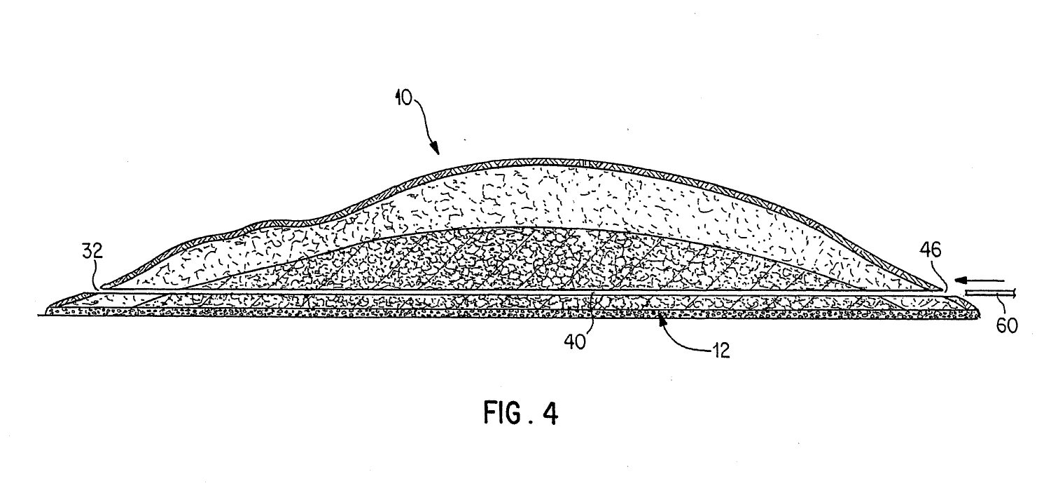

Shown as cross-hatched in FIG. 1 is an area 24 of the solid waste that is saturated with leachate and which presents the hazards described earlier herein. In order to remove the leachate, lateral (non-vertical) wells are formed in the cell to allow the leachate to gravitate from the cell and be handled in a controlled manner. An initial well-drilling stage involves drilling a lateral (non-vertical) hole 40 (FIG. 4) through the landfill cell, more particularly, within the solid waste material, to ensure that the drilling equipment is located high enough above the liner portion of the base 12 to avoid an accidental puncturing of the liner by the drill.

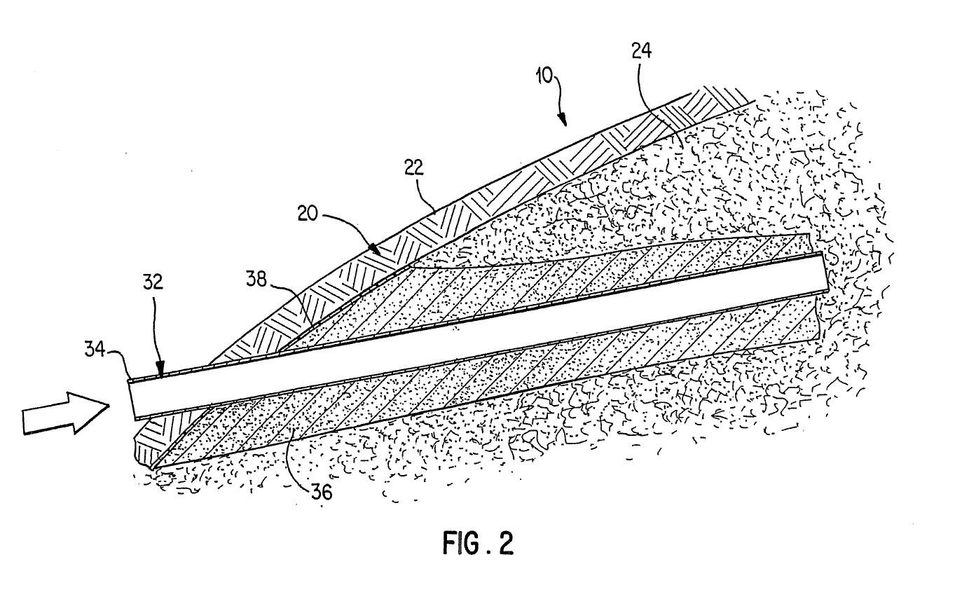

A first step in the hole-forming stage involves creating an entry port 32 through which the drilling operation can safely proceed. Thus, an initial bore is drilled through the cap 20 and into the waste material by conventional horizontal drilling equipment. Then, as shown in FIG. 2, an entry tube 34, preferably in the form of a long steel casing (e.g., a 12-inch diameter, 30-foot long casing) is inserted into the bore. A seal is created around the entry tube where the entry tube intersects the cap 20 to prevent liquid from escaping from the landfill and from eroding the area surrounding the entry tube. The seal comprises a layer 36 of clay-like material such as bentonite in which the entry tube is embedded. An additional seal, e.g. formed by a piece 38 of plastic liner material, such as high density polyethylene (HDPE), is placed around the entry tube. The entry tube is thus ready to receive and support the hole-drilling equipment while conducting a gravity flow of liquid from the cell during the drilling operation.

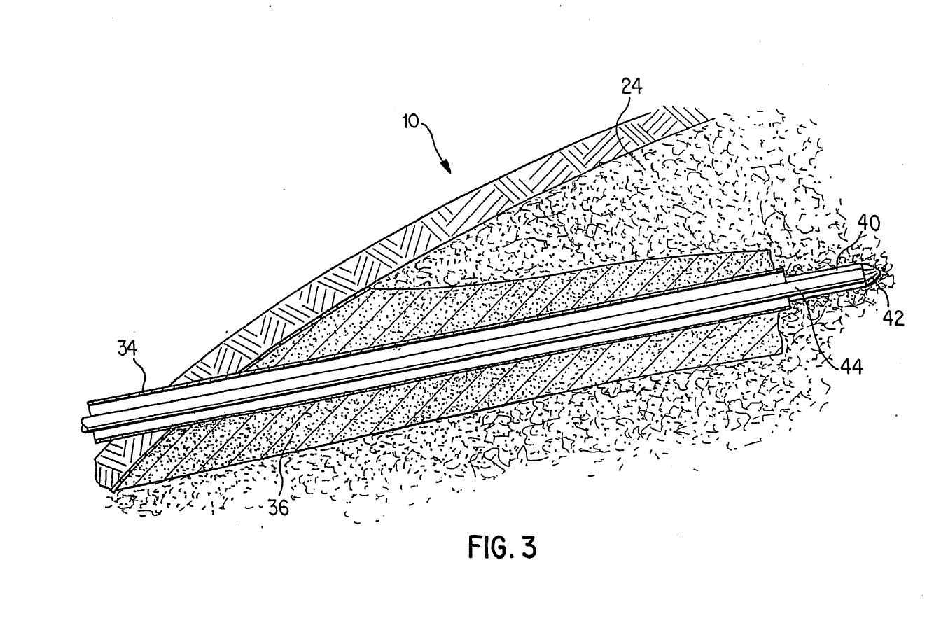

Drilling then proceeds by drilling a hole 40 (serving as a pilot hole) through the solid waste material in an upwardly inclined direction, generally parallel to the liner (see FIGS. 3 and 4). A rotary drilling technique is used which involves a conventional rotating drill head 42 mounted on a drill string 44 to cut and dislodge the material through which it passes. Cuttings are flushed from the hole by drilling fluid which is circulated through the drill bit and eventually gravitates out through the entry port 32 (i.e., a positive gravity drainage).

Normally, when drilling conventional oil and gas wells, the drilling fluid that is used is so-called “drilling mud” which is a non-biodegradable mixture of clays and chemicals that coats the borehole to minimize collapsing risks. However, if used in the present method, that drilling mud, which is not readily removable, would also obstruct the flow of leachate to the drain pipe and defeat the intention of the present method. Thus, the present method uses a material that is more readily removable, namely, a cornstarch-based, clay-free, biodegradable polymer as the drilling fluid, available under the trade name PureGold® Cleandrill, manufactured by Cetco® That material can be washed away once the drain pipe is installed, as will be explained.

The hole 40 is drilled to a length designed to enable the eventually-installed drain pipe to withdraw substantial amounts of leachate. The pilot hole need not be drilled completely through the cell, but a complete penetration to an exit opening 46 would be desirable in order to provide certain advantages, as will be discussed. A guidance and navigation mechanism (not shown) can be used to direct the drill bit during of the drilling operation. Preferably, that mechanism could comprises a DCE Eclipse™ walkover guidance system which is capable of locating the drill bit in the horizontal and vertical planes to identify the pitch of the drill bit as it advances.

Following the drilling of the hole 40, the next step involves widening the hole, preferably by performing one or more back-reaming operations. The back-reaming is facilitated if the pilot hole is drilled completely through the cell, because then it is only necessary to remove the drill bit 42 from the drill string at the exit opening 46 and replace it with a reamer tool. Then, the drill string 44 is pulled back through the hole toward the entry port 32 while the reamer tool enlarges the hole. This may be done a number of times using a progressively larger reamer tool each time until the hole is suitably larger than the outer diameter of the perforated drain pipe 60 to be installed therein.

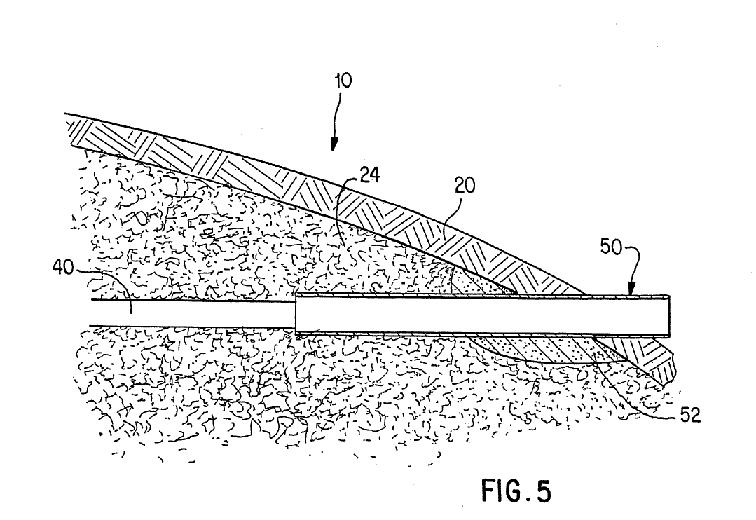

Once the hole 40 has been formed to the desired diameter, an exit tube 50 is installed at the exit end of the hole 40, as shown in FIG. 5. Any suitable tube can be used, such as a stainless steel tube, or a corrugated HDPE tube. The tube 50 is inserted after the hole 40 has been slightly enlarged at its end in order to receive the tube 50. Then, a seal is formed where the tube intersects the cap, such as by a layer of bentonite 52.

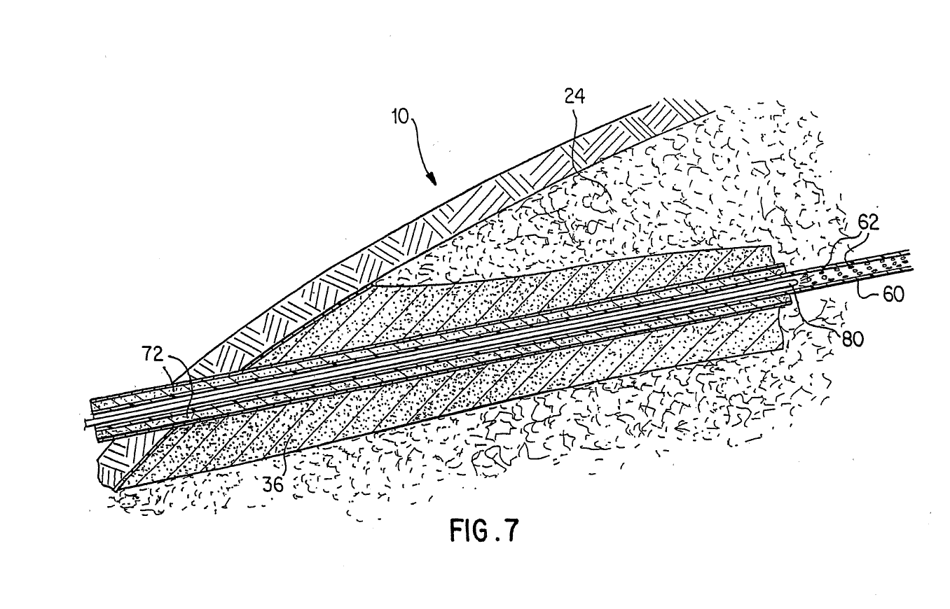

The material of the drain pipe 60 is selected on the basis of a number of factors, such as its ability to withstand the rigors of installation and operation in the landfill environment. Fiberglass-reinforced epoxy pipe (FRE) is well suited as a pipe material because of its long-life, its resistance to corrosion, acids and caustic chemicals, and its flexibility that permits pushing or pulling in long lengths through a drilled hole. The pipe is provided with perforations 62 (see FIG. 7) sized and spaced to handle the expected flow of leachate.

Preferably, the perforations are omitted along a section at each end of the pipe (e.g., 30-foot riser sections), to prevent the pipe from being adversely impacted during pipe completion activities following the pipe installation, as will be explained.

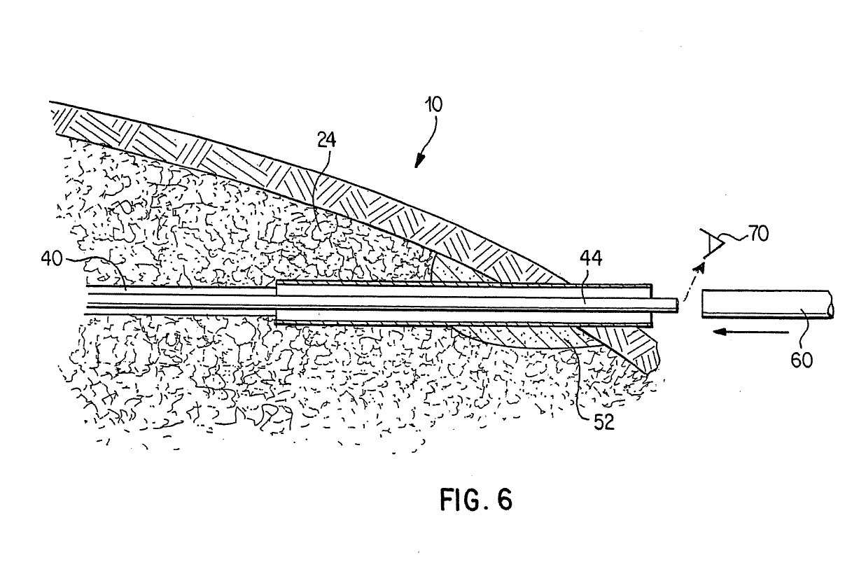

Advantageously, if the hole has been drilled completely through the cell, the insertion of the perforated drain pipe 60 will be facilitated, because the pipe can be pulled through the hole from the exit opening 46 to the entry port 32 by removing the reamer tool 70 from the drill string 44 at the exit opening 46 and attaching the pipe 60 to the end of the drill string, as shown in FIG. 6. Then, by pulling the drill string back through the hole toward the entry port 32, the pipe 60 will be pulled into position within the hole 40. If the hole has not been drilled completely through the cell, the pipe would have to be pushed inwardly through the hole, which can be more difficult than pulling it.

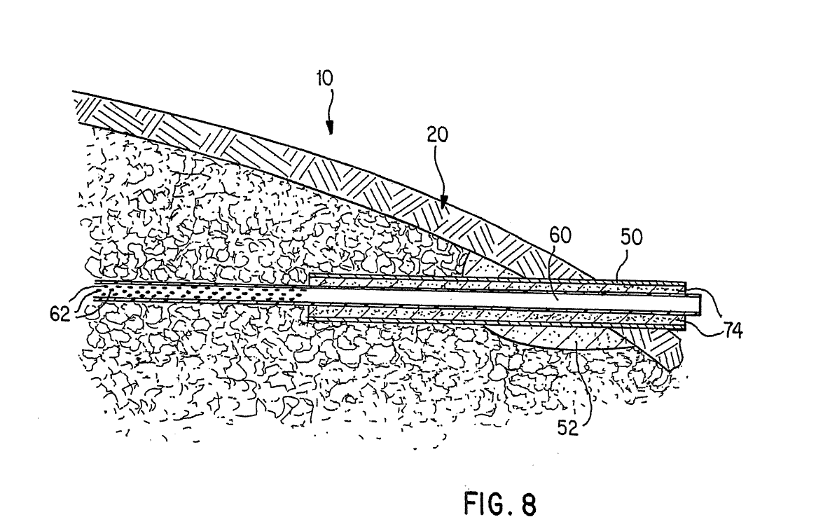

Once the pipe 60 has been installed, the non-perforated end sections of the pipe are completed by being sealed within the entry tube 34 and the exit tube, preferably by inserting bentonite in the spaces 72, 74 that the non-perforated pipe end sections form with the entry tube and the exit tube, respectively (see FIGS. 7 and 8). The exit end of the drain pipe 60 can be closed off if no drainage of leachate therethrough is anticipated.

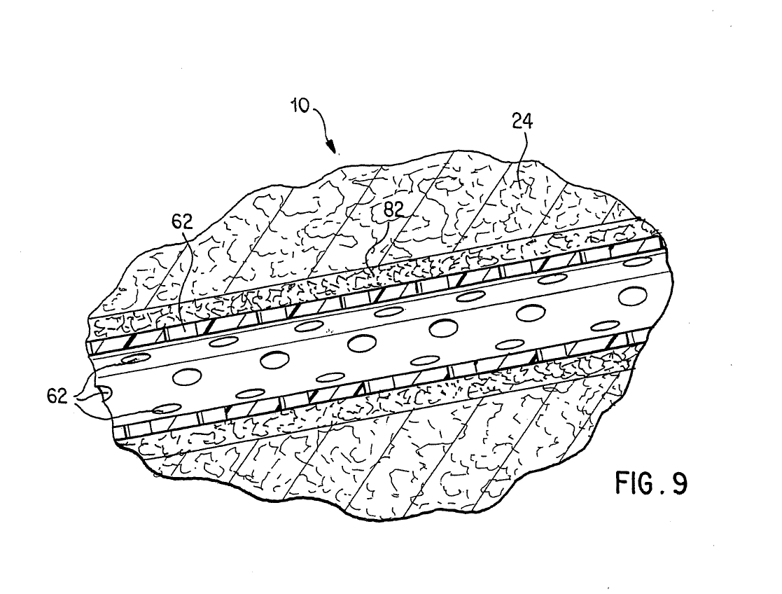

The perforated section of the installed drain pipe 60 will now be surrounded by cuttings of waste material, which have the potential of blocking the pipe's perforations. For example, in many landfill cells, the waste material includes large amounts of plastic bags and plastic films, which can block the exterior sides of the pipe perforations. Thus, a surrounding drainage layer of in situ waste material is to be established around the pipe exterior in order to properly conduct leachate to the perforations. That is accomplished by repeatedly passing through the pipe a jet nozzle 80 (FIG. 7) which emits a high-pressure jet of liquid in a radially outward direction. The jetted liquid will pass through the pipe perforations to break the surrounding waste material into smaller pieces and shred the plastic film, until the drainage layer 82 is formed (see FIG. 9). The liquid which is used could be water, or a chemical intended to break-down the biodegradable material used as a drilling fluid and which coats the waste material surrounding the drain pipe.

It will be appreciated that the afore-describe method of retrofitting an existing landfill cell with a lateral well enables built-up leachate to be gravitationally withdrawn from a landfill cell without the need to drill numerous vertical wells and without the need for expending energy to operate pumps to withdraw leachate through the wells. The withdrawn leachate can be handled in a controlled manner to avoid ecological problems.

It will be appreciated that the method described hereafter is also applicable to operating (non-closed) landfill cells whose leachate collection systems have become inoperative. In that case, there would be no cap; instead, the top surface would be defined by the solid waste material.

Although the present invention has been described in connection with a preferred thereof, it will be appreciated by those skilled in the art that additions, deletions, modifications, and substitutions not specifically described may be made without departing from the spirit and scope of the invention as defined in the appended claims.

What is claimed is:

1. A method of draining leachate from an existing landfill cell by retrofitting the landfill cell with a lateral drainage pipe, wherein the landfill cell includes a base, solid waste disposed above the base, and a cap overlying the solid waste, the base including a liner, the cap including a top surface having portions thereof situated at different respective elevations, wherein leachate from the solid waste tends to accumulate above the base, the method comprising the steps of:
A. installing an entry tube through the top surface of the cap, and sealing the entry tube with respect to surrounding material of the cap; then
B. introducing a drill string through the entry tube and causing a drill bit to drill a hole through the solid waste along a path situated above the base in an upwardly inclined direction from the entry opening;
C. allowing leachate and drilling fluid from the drill bit to gravitate outwardly through the entry tube during step B; then
D. installing a perforated drain pipe in the hole; then
E. passing a nozzle through the drain pipe for emitting a high-pressure liquid jet generally radially outwardly through the drain pipe and into the surrounding solid waste to form a drainage layer of waste material around the drain pipe;
F. forming a seal between the drain pipe and the entry tube subsequent to step D; and
G. allowing leachate to enter the perforated drain pipe and drain from the landfill cell by gravity.

2. The method according to claim 1 wherein step B comprises drilling the hole completely through the solid waste, wherein the hole exits the cap at an exit opening therein disposed at a higher elevation than the entry opening and spaced horizontally therefrom.

3. The method according to claim 2, further including installing an exit tube through the cap at the exit opening in surrounding relationship to a portion of the drain pipe, and forming a seal around the exit tube and between the exit tube and the drain pipe.

4. The method according to claim 2, wherein step D comprises pulling the drain pipe through the hole from the exit opening to the entrance opening.

5. The method according to claim 4 wherein the pulling of the drain pipe is accomplished by attaching the drain pipe to an end of a drill string and pulling the drill string through the hole.

6. The method according to claim 1, wherein step D comprises pushing the drain pipe into the hole from the entry opening.

7. The method according to claim 2, wherein step B includes drilling a pilot hole through the waste material and then replacing the drill bit with a reamer and back-reaming through the hole in a direction from the exit opening to the entry opening to widen the hole.

8. The method according to claim 1, wherein step C comprises using a biodegradable polymer as the drilling fluid.

9. The method according to claim 8, wherein step E comprises emitting a high-pressure jet of a chemical for breaking-down the biodegradable drilling fluid coating the hole.

10. The method according to claim 1, wherein the sealing of the entry tube in step A includes forming a seal around the entry tube at a location where the entry tube intersects the cap, by embedding the entry tube in a layer of clay-like material, and surrounding the entry tube with a piece of plastic liner material.

11. The method according to claim 10, wherein the clay-like material comprises bentonite, and the plastic liner material comprises HDPE.

12. A method of draining leachate from an existing landfill cell by retrofitting the landfill cell with a lateral drainage pipe, wherein the landfill cell includes a base, solid waste disposed above the base, and a cap overlying the solid waste, the base including a liner, the cap including a top surface having portions thereof situated at different respective elevations, wherein leachate from the solid waste tends to accumulate above the base, the method comprising the steps of:
A. installing an entry tube through the top surface of the cap, and sealing the entry tube with respect to surrounding material of the cap; then
B. introducing a drill string through the entry tube and causing a drill bit to drill a hole through the solid waste along a path situated above the base in an upwardly inclined direction from the entry opening, the hole passing completely through the waste material to define an exit opening at an elevation higher than the entry tube;
C. replacing the drill bit with a reamer at the exit opening and back-reaming through the hole to enlarge the diameter of the hole;
D. allowing leachate and drilling fluid from the drill bit to gravitate outwardly through the entry tube during step C;
E. installing an exit tube in the exit opening; then
F. installing a perforated drain pipe in the hole; then
G. passing a nozzle through the drain pipe for emitting a high-pressure liquid jet generally radially outwardly through the drain pipe and into the surrounding solid waste to form a drainage layer of waste material around the drain pipe; and
H. forming seals in the spaces formed by the drain pipe with the entry and exit tubes, respectively, subsequent to step F; and
I. allowing leachate to enter the perforated drain pipe and drain from the landfill cell by gravity.

13. In a method of installing a lateral drain pipe in an existing landfill cell for draining leachate therefrom, the landfill including a base, solid waste disposed above the base, and a cap overlying the solid waste, wherein the drain pipe is installed in a lateral hole drilled through the waste material, the method comprising the steps of:
A. installing an entry tube through the cap, and
B. forming a gas/liquid seal around the entry tube where the entry tube intersects the cap by:
1. embedding the entry tube in a layer of clay-like material, and
2. surrounding the entry tube with a piece of plastic material.

14. The method according to claim 13, wherein the clay-like material is bentonite, and the plastic material is HDPE.
